(19) United States
(12) Patent Application Publication
(10) Pub. No.: US 2015/0317375 A1
(43) Pub. Date: Nov. 5, 2015

(54) SUGGESTING INFORMATION FOR USER PROFILES

(71) Applicants: Frances B. Haugen, Mountain View, CA (US); Kathryn R. Vanderwater, Plainfield, IL (US)

(72) Inventors: Frances B. Haugen, Mountain View, CA (US); Kathryn R. Vanderwater, Plainfield, IL (US)

(21) Appl. No.: 13/630,128

(22) Filed: Sep. 28, 2012

Related U.S. Application Data
(60) Provisional application No. 61/541,687, filed on Sep. 30, 2011.

(51) Int. Cl. G06F 17/30; H04L 29/08; H04L 29/06

(52) U.S. Cl. CPC G06F 17/30598; G06F 17/30867; G06F 17/3087; G06F 17/30528; G06F 17/30604; H04L 65/403; H04L 67/10

(57) ABSTRACT

A process for suggesting information for user profiles includes examining query data sets comprising queries submitted by users of a social networking service, identifying a query term that is common to two or more of the query data sets, defining a group of users based on the common query term, determining an entity specific to the query term, assigning the entity to the group, and providing a suggestion to the users to add information to a user profile indicating an affiliation with the entity.

### CROSS-REFERENCE TO RELATED APPLICATIONS

This application claims priority to U.S. Provisional Application Ser. No. 61/541,687, filed on Sep. 30, 2011, entitled “SUGGESTING INFORMATION FOR USER PROFILES,” the entire contents of which are hereby incorporated by reference.

### BACKGROUND

This specification relates generally to suggesting information for user profiles.

Users of social networking services provide various types of information about themselves. For example, social networking service users can have profile pages that describe themselves, such as details about interests and hobbies. These profile pages can also include websites external to the social networking service that the users feel are relevant to their interests or their online persona or with which they otherwise identify themselves.

### SUMMARY

Described herein is a process for suggesting information for user profiles. The process includes, among other things, examining query data sets comprising queries submitted by one or more users; identifying a query term that is common to two or more of the query data sets; defining a user group based on the common query term; determining an entity specific to the common query term; assigning the entity to the user group; and providing a suggestion to users in the user group to add information to a user profile indicating an affiliation with the entity.

The group of users can be defined based on multiple common query terms.

The query term can include an event specific to the entity.

The query term can include an individual or an organization specific to the entity.

The entity can be a school.

The entity can be a company.

The process can also include identifying an internet protocol address block from which the users submitted the queries; and basing the associating of users in the group to the community on the query term and the internet protocol address.

Implementations may include any or all of the following features.

Advantages can include improving user experience by providing suggestions for information to add to user profiles and by increasing the amount of information users are provided about other users. Advantages can also include determining affiliations between users and entities, and receiving confirmation whether the determination is correct. Advantages can also include modifying content presented to users based on affiliation to entities. Advantages can also include detecting and/or suggesting connections between users, for example, users affiliated with the same entity.

All or part of the systems and processes described herein may be implemented as a computer program product that includes instructions that are stored on one or more non-transitory machine-readable storage media, and that are executable on one or more processing devices. All or part of the systems and processes described herein may be implemented as an apparatus, method, or electronic system that may include one or more processing devices and memory to store executable instructions to implement the stated functions.

The details of one or more implementations are set forth in the accompanying drawings and the description below. Other features, objects, and advantages will be apparent from the description and drawings, and from the claims.

### BRIEF DESCRIPTION OF DRAWINGS

FIG. 1 is an example system for suggesting information for user profiles.

FIG. 2 is a diagram of example sources and social graph information.

FIG. 3 is a flowchart of example operations for suggesting information for user profiles.

Like reference symbols in the various drawings indicate like elements.

### DETAILED DESCRIPTION

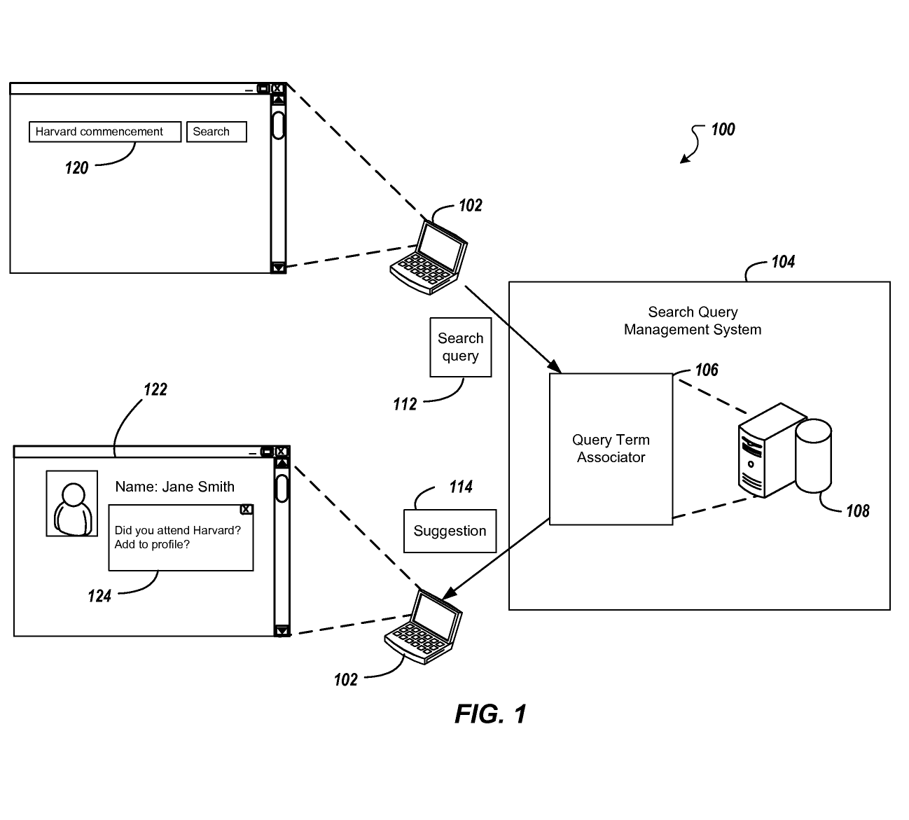

FIG. 1 is an example system for suggesting information for user profiles. An example social networking service is illustrated suggesting information to a user for a user profile. Based on queries submitted by users, the social networking service can infer information about the users. For example, queries can contain terms that are relevant to certain organizations or entities. An entity is a body that has a membership acting or united for a common purpose or by a common characteristic. The social networking service can suggest to users who submit such queries that the users add information indicating an affiliation with the entity to a user profile.

The user can use a client device 102 (e.g., a computer, a mobile device) to submit a search query on a search interface 120 provided by a search query management system 104, which can be a remotely located server-based system. The search query management system (also referred to herein as the system) 104 can include a search system. The client device 102 can be a computer coupled to the search query management system 104 through a local area network (LAN) or wide area network (WAN), e.g., the Internet. The user can submit the search query to a search engine within the search system.

When the user submits the search query 112, the search query 112 is transmitted through a network to the system 104. The system 104 can be implemented as, for example, computer programs running on one or more computers 108 in one or more locations that are coupled to each other through a network.

The search query 112 can be received by a query term associator 106 executed by the system 104. The query term associator 106 can examine the search query 112 for terms that are specific to entities. For example, the search query 112 can include the terms “Harvard commencement.” As the Harvard commencement is an event specific to Harvard University, the query term associator 106 can recognize a relationship between the user who submitted the query term with the identified entity associated with the query, Harvard University.

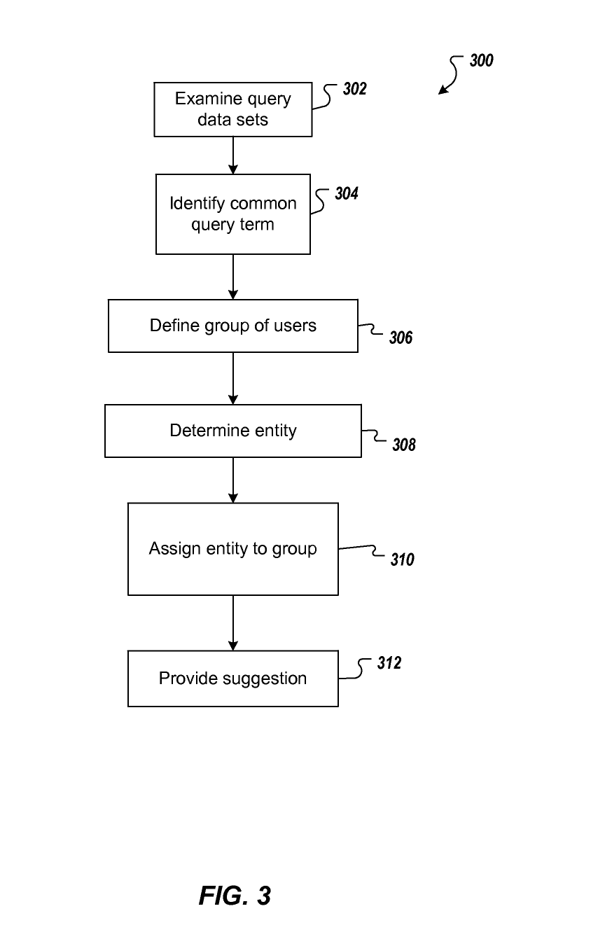

The system 104 can produce and provide a suggestion 114 to the client device 102. The suggestion can be presented on the client device 102, for example on a user profile 122. A suggestion interface 124 can be provided on the user profile 122, for example, asking the user, “Did you attend Harvard University?” The suggestion interface 124 can be presented to the user in response to the user's submission of the query term associated with Harvard University. Additionally or alternatively, the suggestion interface 124 can be presented to the user independent of user action. For example, the system 104 can examine historical query logs to determine the suggestion and provide the suggestion to the user when the user logs on to the user's profile 122. The process will be described further below with reference to FIG. 3.

The suggestion interface 124 can also suggest that the user can add Harvard University to the user's profile 122, for example, under school information. The suggestion interface 124 can also suggest that the user can establish an affiliation or a connection with the entity, Harvard University, for example, by including a Harvard University profile page as a part of the user's social graph.

As used in this specification, a social graph can refer to a single social graph or multiple interconnected social graphs. Distinct social graphs can be generated for different types of connections a user has. For example, a user can be connected with chat contacts in one social graph, email contacts in a second social graph, and a connections from a particular social network in a third social graph. Each social graph can include edges to additional individuals or entities at higher degrees of separation from the user. For example, an email contact can have its own email contacts to others adding a degree of separation from the user (e.g., user→email contact→contact of email contact). These contacts can in turn have additional contacts at another degree of separation from the user. Similarly, a user's connection to someone in a particular social network can then be used to identify additional connections based on that person's connections. The distinct social graphs can include edges connecting one or more social graph to one or more other social graphs.

Types of connections and social graphs can include, but are not limited to other users in which the user is in direct contact (e.g., user mail or chat contact, direct contacts on social sites) and users in which the user is in indirect contact (e.g., friends of friends, connections of users that have a direct connection to the user). In some implementations, the social graph includes content generated by individuals (e.g., blog posts, reviews) as connections to the user. The social graph can include connections within a single network or across multiple networks (separable or integrated).

The social graph can be used to help determine whether to provide suggestions to users. For example, when a user is determined to be a candidate for suggesting an entity to add to the user's profile, the user's social graph can also be examined to increase or decrease a likelihood the suggested entity applies to the user. For example, a user who submits a query including “Harvard commencement” can be identified as a user who may have attended Harvard University. The user's social graph can be examined for contacts who are affiliated with Harvard University. If a threshold number of contacts affiliated with Harvard University are found, the user can be provided with the suggestion. In some implementations, the user can be provided with the suggestion unless a minimum threshold number of contacts affiliated with the entity are not met (e.g., if the user has no or too few contacts affiliated with the entity the suggestion can be withdrawn). In some implementations, the likelihood of the suggestion can have a score that is affected by each affiliated contact or lack of affiliated contacts, with the suggestion being provided based on the likelihood score.

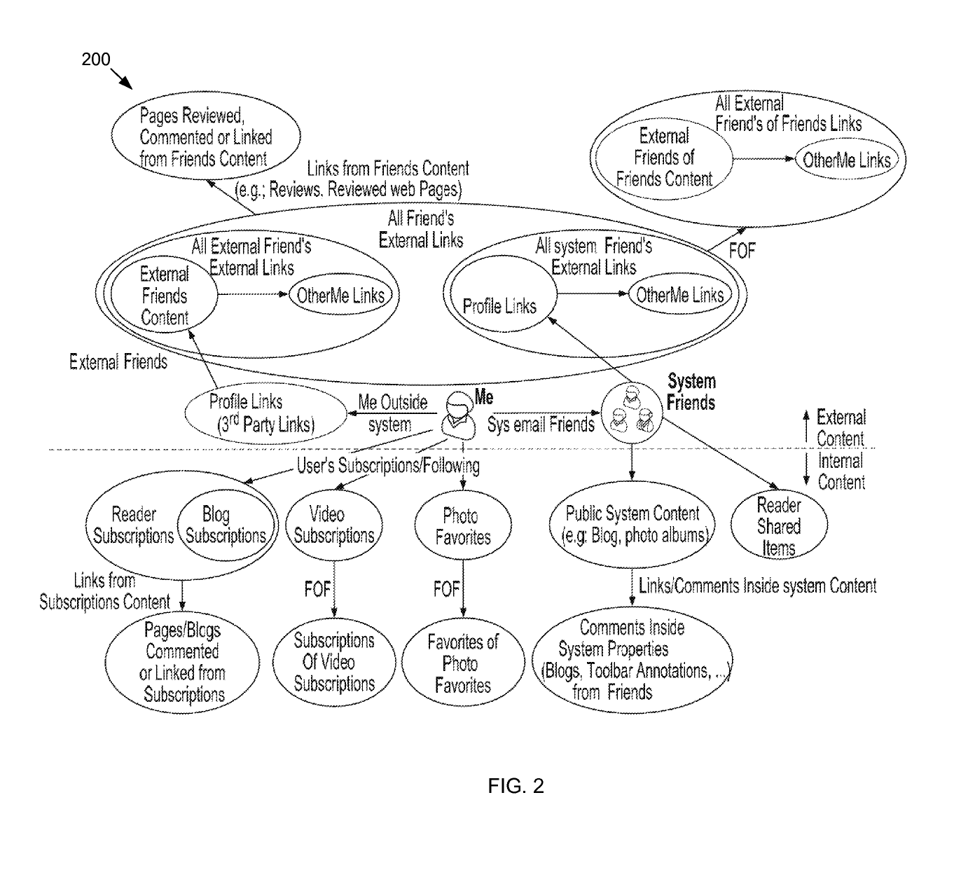

FIG. 2 is a diagram 200 of example sources of social graph information. The user's social graph is a collection of connections (e.g., users, resources) identified as having a relationship to the user within a specified degree of separation. The user's social graph can include people and particular content at different degrees of separation. For example, the social graph of a user can include friends, friends of friends (e.g., as defined by a user, social graphing site, or other metric), the user's social circle, people followed by the user (e.g., subscribed blogs, feeds, or web sites), co-workers, and other specifically identified content of interest to the user (e.g., particular web sites).

Diagram 200 shows a user and the different connections possible to extend a user's social graph to people and content both within a system and across one or more external networks and shown at different degrees of separation. For example, a user can have a profile or contacts list that includes a set of identified friends, a set of links to external resources (e.g., web pages, images, video), and subscriptions to content of the system (e.g., a system that provides various content and applications including e-mail, chat, video, photo albums, feeds, or blogs). Each of these groups can be connected to other users or resources at another degree of separation from the user. For example, the friends of the user each have their own profile that includes links to resources as well as friends of the respective friends. The connections to a user within a specified number of degrees of separation can be considered the social graph of the user. In some implementations, the number of degrees of separation used in determining the user's social graph are user set. Alternatively, a default number of degrees of separation is used. Moreover, a dynamic number of degrees of separation can be used that is based on, for example, the type of connection.

In some implementations, the membership and degree of separation in the social graph is based on other factors, including a frequency of interaction. For example, a frequency of interaction by the user (e.g., how often the user visits a particular social graphing site) or type of interaction (e.g., endorsing or selecting items associated with friends). As interaction changes, the relationship of a particular contact in the social graph can also dynamically change. Thus, the social graph can be dynamic rather than static.

In some alternative implementations, social signals can be layered over the social graph (e.g., using weighted edges or other weights between connections in the social graph). These signals, for example, frequency of interaction or type of interaction between the user and a particular connection, can then be used to weight particular connections in the social graph or social graphs without modifying the actual social graph connections. These weights can change as the interaction with the user changes.

FIG. 3 is a flowchart of example operations for suggesting information for user profiles. A flowchart 300 represents operations of one or more computing devices (e.g., the computer system 108, shown in FIG. 1) to provide suggestions to users. For example, the operations represented in the flowchart 300 may represent operations executed by the query term associator 106 and/or the system 104 (each also shown in FIG. 1). Such operations are typically executed by components (e.g., general processors, specialized processors, etc.) included in a single computing device (e.g., the computer system 108), however, operations may be executed by multiple computing devices. Along with being executed at a single site, operation execution may be distributed among two or more locations.

Operations may include examining 302 query data sets. For example, as described above with reference to FIG. 1, the system 104 can receive a search query 112 from a client device 102, which the system 104 can examine. Alternatively or additionally, the system 104 can examine historical query data sets, for example, search queries submitted for a past time period by users. For example, the system 104 can access a session log. Thus, the system 104 can execute the operations represented on the flowchart 300 in response to a query received by a user, or at a time independent of queries received by users.

Operations may also include identifying 304 common query terms among the query data sets. The query term can be one word or multiple words or phrases submitted as a search query. For example, the query data sets can be examined and the query term “Harvard commencement” can be found in common among some of the search queries in the query data set. In some implementations, query terms that include some of the same words or forms of words can be considered common. For example, “Harvard University commencement” and “commencement Harvard” can also be considered as a common query term as “Harvard commencement.” In some implementations, exact matches are considered common query terms.

Operations may also include defining 306 a group of users based on the common query terms. The users who submitted the search queries that include the common query term are defined as a group. For example, the users who submitted the search queries for “Harvard commencement” can be clustered as a group. Additionally or alternatively, users can be added to existing groups. Groups can also overlap, or include subgroups within the groups, or be combined to form new groups or additional groups.

Operations may also include determining 308 an entity that is specific to the common query term. The entity can be determined by the specificity of the common query term. For example, the common query term can include the name of an event specific to the entity (e.g., a social event, a class, a conference) or an individual or group (e.g., a sports team, a club, a professor, a CEO) specific to the entity. For example, “Harvard commencement” can be considered an event specific to Harvard University and thus the entity determined by the query term “Harvard commencement” can be Harvard University. As another example, “Logarhythms” is the name of an a cappella group at MIT, and thus the entity determined by the query term “Logarhthyms” can be MIT. The common query term can also include words and terminology specific to the entity or used primarily by members of the entity.

The entities can be determined using a lookup table with a list of entities and associated query terms that specify events or individuals specific to the entities. Items can be added to the lookup table using information received from various sources, such as the entities themselves, or other sources of information (e.g., news articles, websites operated by the entities, informational websites). Items can also be added to the lookup table by determining from the groups common known characteristics of the users in the group. For example, in the “Harvard commencement” group, if a threshold number or percentage of the users in the group already indicate an affiliation with Harvard University, the system 104 can determine that the entity, Harvard University, might be associated with the search query, “Harvard commencement,” upon which the group is based. Thus, the system 104 can add “Harvard commencement” to the lookup table, corresponding to Harvard University.

Operations may also include assigning 310 the entity to the group. Once the entity specific to the common search query has been determined, the entity can be assigned to the group of users defined by the common search query. Operations may also include providing 312 a suggestion to the users in the group to add information to respective user profiles indicating an affiliation with the entity. For example, the users in the group can be asked whether they are, in fact, affiliated with the entity. The users can also be asked whether the user wants to indicate on her user profile that the user is affiliated with the entity. The user can also be suggested to establish a connection with the entity. For example, if the user is in the “Harvard commencement” group, the user can be asked whether she attended Harvard. The user can also be asked if she wants to include Harvard in a “school” field on her user profile. The user can also be asked if she wants to be a member of a Harvard group or Harvard user page.

The system can also receive feedback on the suggestions from the users. For example, the users of a group can be associated with Example College. The users can be asked if the users attended Example College. If the system receives responses from the users indicating that the responding users did not attend Example College, the system can determine that the group was incorrectly assigned to the entity Example College. The system can determine incorrect assignments based on a threshold number of negative responses, or a threshold ratio of negative responses to positive responses. The responses can also be considered based on how many users act upon the suggestions provided by the system. For example, using the Example College group, if a threshold percentage of users who are provided the suggestion to add Example College to user profiles do not add the information, the system can determine that the group was incorrectly assigned.

The groups defined by the common query terms can also be defined by multiple common query terms. Alternatively or additionally, groups can be further defined into subgroups. For example, a group can be defined as having submitted at least a threshold number of search queries including terms specific to an entity.

The groups can also be defined by additional signals along with common query terms. For example, an IP (internet protocol) address range can be used to help define groups or to help determine the entities specific to the query terms. For example, a group of users who submitted the search query “commencement” who also submitted the search from an IP address range belonging to Example College can be defined as a group. The combination of the common query term and the IP address range can help determine the specified entity as Example College. Additional signals can also include a time component of the search queries. For example, a group can be defined by the common query term “commencement start time,” who submitted the search query the night before or the morning of the actual commencement for Example College. Or, a group can be defined by users who submit a search term “Example Company” shortly after a news item from the Example Company.

In addition to suggesting to the users to add information indicating an affiliation with the entity, the users can also be presented more information related to the entity. For example, news items relating to the entity can receive a greater weighting in displaying information to the user in an information stream.

An affiliation with the entity can include employees of a company or students or alumni of a school. Additionally, the affiliations can be of lesser degrees, such as a supplier for a company or a family member of a student. The groups can be defined to include degrees of affiliation in the suggestions provided by the system. For example, a group of users who submit queries specific to an entity multiple times a day may be suggested a stronger affiliation, such as a student or an employee than a group of users who submit queries specific to the entity a few times a month. Alternatively or additionally, the degrees of affiliation can be based on the query term, for example, users who submit a query term that is more generic or loosely related to the entity can be suggested as a weaker affiliation.

While entities have been described as organizations and establishments (e.g, schools and companies), entities can also include communities and groups of people based on characteristics (e.g., profession, geographic location, hobbies, belief systems etc.).

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

What is claimed is:

1. A method comprising:
examining, by one or more processing devices, query data sets comprising queries submitted over a network by computing devices of users;
identifying, by one or more processing devices, a query term that is common to two or more of the query data sets;
defining, by one or more processing devices, a user group based on the common query term;
determining, by one or more processing devices, an entity specific to the user group, the entity being an organization for which more than a threshold number of users in the user group have a pre-existing affiliation;
assigning, by one or more processing devices, the entity to the user group; and
providing, by one or more processing devices, data representing a suggestion to computing devices of one or more users in the user group, the suggestion to add information to a user profile indicating an affiliation with the entity.

2. The method of claim 1, wherein the user group comprises users of a social networking service.

3. The method of claim 2, further comprising:
identifying, by one or more processing devices, connected users on social graphs of the users in the user groups;
determining, by one or more processing devices, whether the connected users have an affiliation with the entity; and
based on determination of affiliations of the connected users, providing the data representing a suggestion to the users in the user groups.

4. The method of claim 1, wherein the user group is defined based on multiple common query terms.

5. The method of claim 1, wherein the query term comprises an event specific to the entity.

6. The method of claim 1, wherein the query term comprises an individual or an organization specific to the entity.

7. The method of claim 1, wherein the entity is a school.

8. The method of claim 1, wherein the entity is a company.

9. The method of claim 1, further comprising:
identifying, by one or more processing devices, an internet protocol address block from which users in the user group submitted the queries; and
associating, by one or more processing devices, users in the user group to the entity based on query terms submitted by users and based on internet protocol address blocks.

10. The method of claim 1, further comprising:
receiving, by one or more processing devices, feedback from one or more of the users of the user group, the feedback indicating an accuracy of the suggestion; and
modifying, by one or more processing devices, the assignment of the entity to the user group based on the feedback.

11. The method of claim 1, further comprising:
defining, by one or more processing devices, sub-groups of the user group; and
modifying, by one or more processing devices, the suggestion to include a level of degree of affiliation with the entity.

12. The method of claim 11, wherein the sub-groups are defined based on a quantity of queries submitted comprising query terms related to the entity.

13. An electronic system comprising:
memory to store instructions that are executable; and
one or more processing devices to execute the instructions to perform operations comprising:
examining query data sets comprising queries submitted over a network by computing devices of users;
identifying a query term that is common to two or more of the query data sets;
defining a user group based on the common query term;
determining an entity specific to the user group, the entity being an organization for which more than a threshold number of users in the user group have a pre-existing affiliation;
assigning the entity to the user group; and
providing data representing a suggestion to computing devices of one or more users in the user group, the suggestion to add information to a user profile indicating an affiliation with the entity.

14. The system of claim 13, wherein the user group comprises users of a social networking service.

15. The system of claim 14, wherein the operations comprise:
identifying, by the one or more processing devices, connected users on social graphs of the users in the user groups;
determining, by the one or more processing devices, whether the connected users have an affiliation with the entity; and
based on determination of affiliations of the connected users, providing the data representing a suggestion to the users in the user groups.

16. The system of claim 13, wherein the user group is defined based on multiple common query terms.

17. The system of claim 13, wherein the query term comprises an event specific to the entity.

18. The system of claim 13, wherein the query term comprises an individual or an organization specific to the entity.

19. The system of claim 13, wherein the entity is a school.

20. The system of claim 13, wherein the entity is a company.

21. The system of claim 13, wherein the operations comprise:
identifying, by the one or more processing devices, an internet protocol address block from which the users in the user group submitted the queries; and
associating, by the one or more processing devices, users in the user group to the entity based on query terms submitted by users and based on the internet protocol address blocks.

22. The system of claim 13, wherein the operations comprise:
receiving, by the one or more processing devices, feedback from one or more of the users of the user group, the feedback indicating an accuracy of the suggestion; and
modifying, by the one or more processing devices, the assignment of the entity to the user group based on the feedback.

23. The system of claim 13, wherein the operations comprise:
defining, by the one or more processing devices, sub-groups of the user group; and
modifying, by the one or more processing devices, the suggestion to include a level of degree of affiliation with the entity.

24. The system of claim 23, wherein the sub-groups are defined based on a quantity of queries submitted comprising query terms related to the entity.

25. One or more non-transitory machine-readable storage media storing instructions that are executable by one or more processing devices to perform operations comprising:
examining, by the one or more processing devices, query data sets comprising queries submitted over a network by computing devices of users;
identifying, by the one or more processing devices, a query term that is common to two or more of the query data sets;
defining, by the one or more processing devices, a user group based on the common query term;
determining, by the one or more processing devices, an entity specific to the user group, the entity being an organization for which more than a threshold number of users in the user group have a pre-existing affiliation;
assigning, by the one or more processing devices, the entity to the user group; and
providing, by the one or more processing devices, a suggestion to computing devices of one or more users in the user group, the suggestion to add information to a user profile indicating an affiliation with the entity.
